(19) United States
(12) Patent Application Publication
(10) Pub. No.: US 2014/0069091 A1
(43) Pub. Date: Mar. 13, 2014

(54) ELECTRO-HYDRAULIC SYSTEM FOR CONTROLLING MULTIPLE FUNCTIONS

(71) Applicants: Germano Franzoni, Prairie View, IL (US); Jarmo Harsia, Chicago, IL (US); Roger Lowman, Simpsonville, SC (US)

(72) Inventors: Germano Franzoni, Prairie View, IL (US); Jarmo Harsia, Chicago, IL (US); Roger Lowman, Simpsonville, SC (US)

(73) Assignee: Parker Hannifin Corporation, Cleveland, OH (US)

(21) Appl. No.: 14/005,597

(22) PCT Filed: Mar. 5, 2012
(86) PCT No.: PCT/US12/27679

§ 371 Date: Nov. 25, 2013

Related U.S. Application Data
(60) Provisional application No. 61/453,644, filed on Mar. 17, 2011.
(60) Provisional application No. 61/453,686, filed on Mar. 17, 2011.

(51) Int. Cl. F15B 11/16; F15B 13/02

(52) U.S. Cl. CPC F15B 11/162; F15B 11/165; F15B 13/022
USPC 60/422; 60/429; 60/445

(57) ABSTRACT

Electro-hydraulic systems (10, 110, 210, 310, 410, 510, 610 and 710) control multiple hydraulic motors without objectionable erratic or jerky motion. The system (10) includes a variable displacement pump (20), an electronic controller (30), a direction control valve (40), first and second pump outlet valves (60) and (70), and a fluid reservoir (80). The pump (20) does not require or use a load feedback signal to control pump output. The controller (30) provides electric control signals to a pump control (21) and to individual hydraulic motors (51). A load sense circuit (46) resolves a highest load sense pressure Ps, which is communicated to the first and second pump outlet valves (60) and (70). The first pump outlet valve (60) limits the maximum load sense pressure. The second pump outlet valve (70) limits the maximum pressure differential between the pump outlet and the load sense pressure.

### CROSS REFERENCE TO RELATED APPLICATIONS

The present application claims the benefit of the filing dates of U.S. Provisional Application No. 61/453,644 filed Mar. 17, 2011, and U.S. Provisional Application No. 61/453,686 filed Mar. 17, 2011, the disclosures of which are incorporated herein by reference in their entirety.

### TECHNICAL FIELD

This invention relates to electro-hydraulic systems. More specifically, this invention relates to electro-hydraulic systems for controlling multiple functions.

### BACKGROUND OF THE INVENTION

Electro-hydraulic systems are widely used to control multiple functions in various types of equipment. For example, electro-hydraulic systems are widely used to control multiple motion functions of mobile equipment such as farm equipment, construction equipment, loading equipment and moving equipment.

Prior art electro-hydraulic systems for such mobile equipment include a hydraulic pump and multiple hydraulic motors such as, for example, linear hydraulic cylinder actuators or rotary hydraulic actuators. The linear or rotary hydraulic motors are each associated with various motion functions of the equipment such as, for example, lifting and lowering, extending and retracting, rotating, tilting and swinging. If the mobile equipment is a backhoe, for example, the hydraulic motors may each be associated with a function for moving the boom and bucket of the backhoe. Hydraulic systems of this type also include primary direction control valves that direct hydraulic fluid under pressure from the pump or pumps to one or more of the hydraulic motors to control the direction of movement of the hydraulic motors. The primary direction control valves may also meter the hydraulic fluid flow to the hydraulic motors, to control the rate or speed of movement of the hydraulic motors. Electrical operator controls provide an interface between the operator and the control valves, to direct hydraulic fluid from the pump or pumps to the motors to cause the system to provide the desired motion function.

In electro-hydraulic systems of this type, it is desirable to provide a single hydraulic pump that supplies fluid under pressure to multiple functions. These single pump multiple function electro-hydraulic systems include either a fixed displacement pump or a variable displacement pump. In the case of a fixed displacement pump, the output flow from the pump is constant for a given rotational velocity of the pump. The hydraulic motors use some or all of the constant output flow, and an excess flow relief valve directs excess pump flow not required by the hydraulic motors to the system reservoir or drain. In the case of a variable displacement pump, the output of the pump is controlled by an electric control signal from an operator interface electronic controller and synchronized to the flow requirements of the system.

In electro-hydraulic systems of this type, technical problems include system complexity, abrupt changes in flow to one hydraulic motor causing undesirable erratic or jerky movement in other hydraulic motors, and tuning or synchronizing, particularly as related to transient conditions in the system. It would be desirable to provide such a sole electrical control hydraulic system in which an abrupt change in the flow to one of the hydraulic motors, such as for example by action of the operator or by the hydraulic motor reaching the end of its stroke or encountering an abrupt increased resistance to its movement, would not cause objectionable erratic movement or jerking in any of the other hydraulic motors, particularly under transient conditions. Further, it would be desirable to provide such a system in which precise synchronization or tuning of the system for such transient conditions would not be required to minimize such erratic movement or jerking. Still further, it would be desirable to provide such a system in which hydraulic motor position sensors to measure the motor or function position or a parameter related to it would not be required to minimize such objectionable erratic movement or jerking.

In electro-hydraulic systems for controlling multiple functions, it may also be desirable to provide a priority flow to one of the hydraulic motors for a priority function. A standby flow may be provided to the priority function, to assure the requirements of the priority hydraulic motor will always be met by the pump output even under standby conditions that include low pump rotational velocity. Prior art systems of this type may utilize a fixed displacement pump with a priority control valve. In these systems, the standby flow is the full pump flow, which may generate parasitic pressure losses and heat in the system, may not allow optimal power management of the system, and may provide less productivity. Other prior art systems of this type may utilize a separate hydraulic circuit with a separate dedicated pump for the priority functions. The priority function flow from the separate pump may need to be sized for engine idle conditions, thus at higher engine speeds the priority circuit may generate higher losses.

### SUMMARY OF THE INVENTION

The present invention provides an electro-hydraulic system for controlling multiple functions of mobile equipment. The invention provides a system that provides sole electric control of the pump, while limiting the flow of hydraulic fluid to the multiple functions during transient system flow conditions to minimize or eliminate erratic or jerky motion. The invention accomplishes this without requiring precise synchronizing or tuning of the system. The invention also provides a system that is able to assure priority flow to one of the functions.

An electro-hydraulic system for controlling multiple motion functions according to the invention includes a hydraulic pump, a plurality of hydraulic motors each associated with at least one of the motion functions, a plurality of direction control valve sections, at least one pump outlet valve, an electronic controller, and a hydraulic fluid reservoir. The hydraulic pump has a pump inlet receiving hydraulic fluid from the reservoir, a pump outlet, and an electro-hydraulic pump control that sets the hydraulic fluid flow rate from the pump inlet to the pump outlet. The direction control valve sections each include a valve inlet that receives hydraulic fluid from the pump outlet, a valve outlet, and a valve member movable in the section for controlling hydraulic fluid flow between the valve inlet and the valve outlet. The hydraulic motors each have a hydraulic motor inlet that receives hydraulic fluid from a valve outlet and a hydraulic motor outlet returning hydraulic fluid to the hydraulic fluid reservoir. The pump outlet valve communicates fluid flow from the pump outlet away from the direction control valve sections under predetermined conditions. The electronic controller has an operator interface input, at least one electric output, a communication link establishing communication between at least one electric output and the electro-hydraulic pump control. The electric output and link is the sole control input to the pump to control the hydraulic fluid flow between the pump inlet and the pump outlet.

The hydraulic pump is a variable displacement pump that has a pressure limiting device set to a pump outlet pressure limit value Pₚ. The hydraulic motors each provide a load sense signal to a logic circuit, and the logic circuit communicates the highest load sense pressure of the hydraulic motors to the pump outlet valve. The pump outlet valve limits the maximum load sense pressure to a pressure limit value Pₛ. The system further includes a second pump outlet valve, and the second pump outlet valve is a differential pressure valve that receives the maximum load sense pressure Pₛ from the logic circuit and that receives the pump outlet pressure Pₚ from the pump outlet. The differential pressure valve is set to limit the differential pressure between the pump outlet pressure Pₚ and the load sense pressure Pₛ to a differential pressure limit P_{d}. The value of Pₚ is set to be greater than or equal to Pₛ and less than or equal to the sum of Pₛ plus P_{d}. Preferably, the value of Pₚ is set to be greater than the value of Pₛ and less than the sum of Pₛ plus P_{d}. Each pump outlet valve discharges hydraulic fluid from the pump outlet to the reservoir.

Each of the direction control valve sections includes an electro-hydraulic valve member control that controls the position of the valve member in the section. Another communication link establishes communication between another controller output and each of the electro-hydraulic valve member controls. Each of the valve sections includes a metering element and a direction control element, and one of the controller outputs provides the sole external control for each of the valve section metering elements and direction control elements. Each of the valve sections includes a compensator controlling the fluid pressure drop across a metering element.

The second pump outlet valve can alternatively limit the pump outlet pressure to a pressure limit value Pₘ, and the value of Pₘ is set to be greater than Pₚ.

The pump outlet valve can be a priority flow control valve. The priority flow control valve can maintain a minimum hydraulic fluid flow through the priority flow control valve to a priority function hydraulic motor when none of the first mentioned plurality of hydraulic motors is receiving hydraulic fluid flow and under all other operating conditions. A hydraulic pressure feedback communication link can extend between the priority function hydraulic motor and the priority flow control valve. A position sensor associated with each of the first mentioned plurality of hydraulic motors can provide an electric signal output, and a communication link can communicate each sensor electric signal output as an input command signal to the controller.

### BRIEF DESCRIPTION OF THE DRAWINGS

Embodiments of this invention will now be described in further detail with reference to the accompanying drawings, in which:

FIG. 1 is a schematic circuit diagram of a first preferred embodiment of an electro-hydraulic system, showing the use of a pre-compensated load sensing primary direction control valve;

FIG. 2 is a detailed schematic circuit diagram of one valve section of the pre-compensated primary direction control valve shown in FIG. 1;

FIG. 3 is a schematic circuit diagram of a second embodiment of an electro-hydraulic system, showing the use of a post-compensated load sensing primary direction control valve;

FIG. 4 is a detailed schematic circuit diagram of one valve section of the post-compensated primary direction control valve shown in FIG. 3;

FIG. 5 is a schematic circuit diagram of a third embodiment of an electro-hydraulic system, showing the use of a non-compensated load sensing primary direction control valve;

FIG. 6 is a detailed schematic circuit diagram of one valve section of the non-compensated primary direction control valve shown in FIG. 5;

FIG. 7 is a schematic circuit diagram of a fourth embodiment of an electro-hydraulic system, showing the use of a pre-compensated load sensing primary direction control valve;

FIG. 8 is a schematic circuit diagram of a fifth embodiment of an electro-hydraulic system, showing the use of a post-compensated load sensing primary direction control valve;

FIG. 9 is a schematic circuit diagram of a sixth embodiment of an electro-hydraulic system, showing the use of a non-compensated load sensing primary direction control valve;

FIG. 10 is a schematic circuit diagram of a seventh embodiment of an electro-hydraulic system, showing the use of a priority valve and a non-compensated primary direction control valve;

FIG. 11 is a detailed schematic circuit diagram of one valve section of the non-compensated primary direction control valve shown in FIG. 10;

FIG. 12 is a schematic circuit diagram of an eighth embodiment of an electro-hydraulic system, showing the use of a priority valve and a non-compensated primary direction control valve; and

FIG. 13 is a schematic circuit diagram of a priority control valve used in the systems of FIGS. 9, 10 and 12.

### DETAILED DESCRIPTION OF THE DRAWINGS

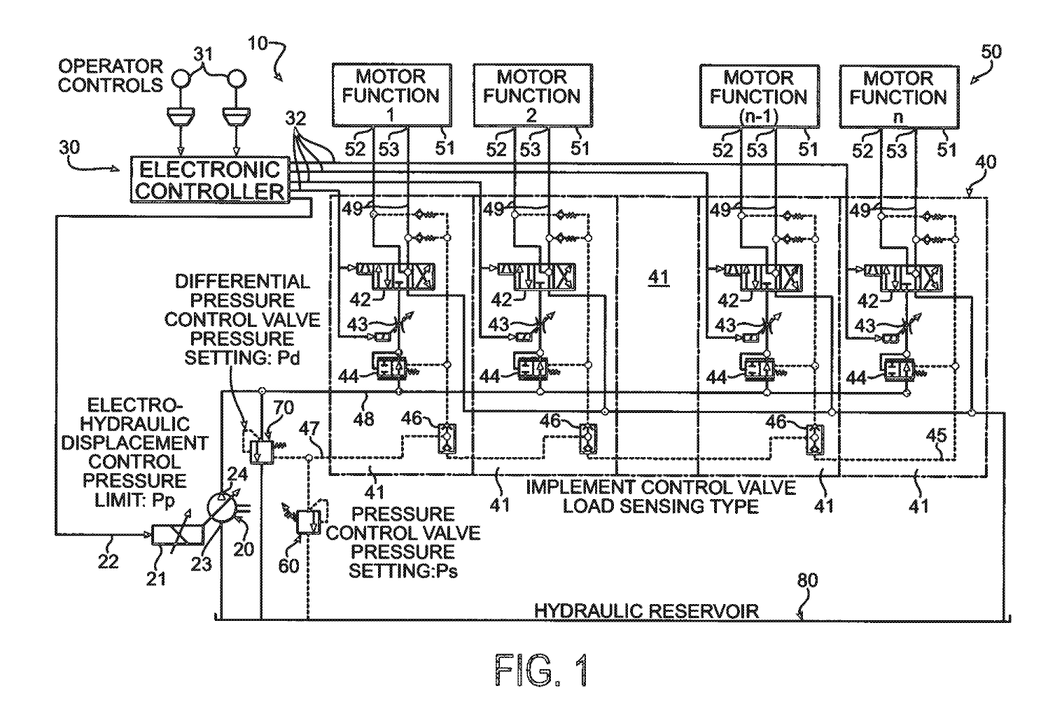

Referring now to the drawings in greater detail, FIG. 1 illustrates a first preferred embodiment of the invention that includes an electro-hydraulic system 10 The system 10 is arranged on equipment having motion functions such as, for example, mobile equipment (not shown) to control multiple motion functions as described below. The mobile equipment in the preferred embodiment is a tractor, and alternatively the system 10 may be arranged on other types of equipment. The system 10 includes a hydraulic pump 20 that is rotatably driven by a prime mover (not shown) such as, for example, an internal combustion engine of the equipment. The system 10 also includes an electronic controller 30, a load sensing direction control valve 40, multiple linear or rotary hydraulic motors 50, a load sense relief valve 60, a margin relief valve 70, and a hydraulic reservoir 80.

The hydraulic pump 20 is preferably a variable displacement pump with an electro-hydraulic pump control 21 arranged so that the pump fluid output displacement is proportional to an electric input signal received by the control 21, wirelessly or hard wired, through a communication link 22. In the preferred embodiment, the communication link 22 is a suitable wire connection. The pump 20 has an inlet 23 that is hydraulically connected to and receives hydraulic fluid from the reservoir 80. The pump 20 has an outlet 24, and the pump control 21 includes a device for limiting the pump pressure at the outlet 24 to a maximum pump pressure Pₚ. Alternatively, the pressure limiting device may be built into the pump 20. The pressure limiting device can be electric or of a different nature, such as mechanical or hydro-mechanical. When the limit pressure Pₚ is reached, the device overrides the external commands from the pump controller 30 described further below and reduces the pump displacement in order to not exceed the limit pressure Pₚ under steady state conditions. In the preferred embodiment, the pump 20 is a model P1 swash plate axial piston pump with remote digital electronic control, available from Parker Hannifin Corporation of Cleveland, Ohio USA (parker.com) and described in Parker Hannifin bulletin HY28-2665-01/P1/EN.

The electronic controller 30 is a programmable digital electronic controller. The controller 30 includes operator interface input controls 31, which allow the equipment operator to control operator interface outputs from the controller 30 to the pump 20 through communications link 22 and to the direction control valve 40 through communications links 32 as more fully described below. In the preferred embodiment, the controller 30 is an IQAN electronic controller available from Parker Hannifin Corporation of Cleveland, Ohio USA (parker.com) and described in Parker Hannifin Bulletin HY33-8368/UK.

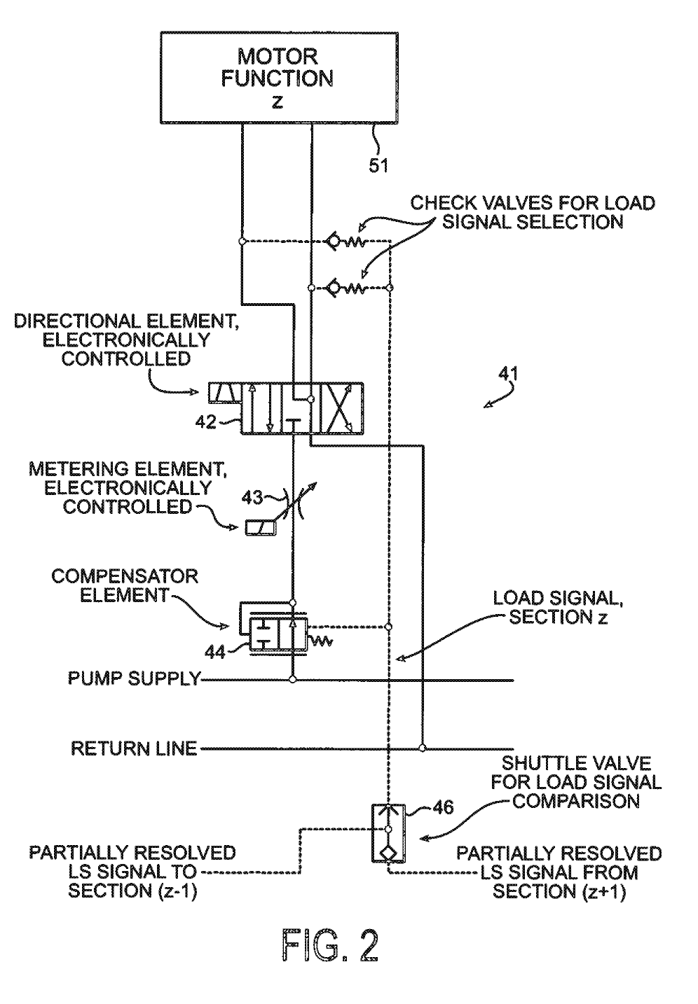

Referring now to FIGS. 1 and 2, the direction control valve 40 includes n control valve sections 41. Each of the n control valve sections 41 is illustrated schematically in FIG. 2 and is associated with and controls hydraulic fluid flow from the pump 20 to n individual hydraulic motor 51 of the plurality of hydraulic motors 50. Each of the hydraulic motors 51 is associated with a motion function, which for example may be an implement function of the mobile equipment on which the hydraulic system 10 is utilized. The specific valve section 41 and hydraulic motor 51 illustrated in FIG. 2 is associated with motion function z. The valve sections 41 each include a 6-way control element 42 that includes an electric control device and that receives a command signal from the controller 31 through communication fink 32 to move its associated hydraulic motor 51 in either of two directions or to hold its associated hydraulic motor in a fixed position. Each valve section 41 further includes a metering element 43 that includes an electric control device and that also receives a command signal from the controller 31 through communication link 32 to control the rate of hydraulic fluid flow through the valve section 41 to its associated hydraulic motor 51. The metering element 43 may for example be a variable size metering orifice of the direction control element 42, with the size of the orifice proportional to the command signal from the controller 31. Each valve section 41 further includes a pre-compensated element 44, which seeks to maintain a constant pressure drop across its associated metering element 43 to seek to provide a predictable predetermined flow rate through the metering element 43 to the associated hydraulic motor 51 for any position of the metering element 43 that is commanded by the controller 30. Each compensator element 44 is a normally open device in which the pressure downstream of the metering element 43 and a spring act in an opening direction, while the pressure upstream of the metering element 43 is acting in the closing direction. The valve 40 is a load sense valve and includes a load sense logic circuit 45. The logic circuit 45 includes a check valve 46 associated with each valve section 41 (other than the n valve section), and each hydraulic motor 51 provides its load demand pressure or operating pressure to its associated check valve 46. The check valves 46 then resolve and communicate the highest load demand pressure of the plurality of hydraulic motors 50 to load sense hydraulic communication link 47. Hydraulic fluid in the system 10 flows from the pump outlet 24 to valve inlet 48, flows to and from hydraulic motors 51 through hydraulic motor inlets and outlets 52, 53, and flows through valve outlet 49 back to the reservoir.

With reference to FIG. 1, the load sense relief valve 60 receives the resolved highest load sense demand pressure from the load sense communication link 47. The valve 60 is a pressure relief valve that is set to relieve or limit the highest load demand pressure to a maximum Pₛ. If the load demand pressure received from the load sense communication link 47 reaches and begins to exceed the maximum pressure limit Pₛ, the valve 60 begins to open and throttle or communicate the load sense communication link 47 to the reservoir 80 to discharge hydraulic fluid to the reservoir and prevent the highest load demand pressure in the system 10 from exceeding the limit Pₛ. In the preferred embodiment, the load sense relief valve 60 may be similar to the relief valve illustrated in inlet section AS of mobile directional control valve L90LS available from Parker Hannifin Corporation of Cleveland, Ohio USA (parker.com) and described in Parker Hannifin catalog HY17-8504/UK.

The margin relief valve 70 receives the resolved highest load sense demand pressure from the load sense communication link 47. The valve 70 is also connected to and receives the pump pressure from the pump outlet 24. The valve 70 is a differential pressure relief valve that is set to relieve or limit the difference between the resolved load sense demand and the pump outlet pressure and to a maximum differential P_{d}. If the difference between the load demand pressure received from the load sense communication link 47 and the pump outlet pressure reaches and begins to exceed the maximum differential pressure limit P_{d}, the valve 70 begins to open and throttle or communicate the pump outlet 24 to the reservoir 80 to discharge hydraulic fluid to the reservoir and prevent this differential pressure in the system 10 from exceeding the limit P_{d}. In the preferred embodiment, the margin relief valve 70 may be similar to the differential pressure relief valve illustrated in the above referenced inlet section AS of mobile directional control valve L90LS available from Parker Hannifin Corporation of Cleveland, Ohio USA (parker.com) and described in Parker Hannifin catalog HY17-8504/UK.

The electro-hydraulic system 10 illustrated in FIG. 1 provides sole electrical control of the variable displacement pump 20 and valve sections 41 by the controller 30, without requiring sensors on the valve sections 41 or their associated functions as used in prior art sole electrical control hydraulic systems. Such sensors may generally be used in prior art sole electrical control hydraulic systems to indicate the position of the hydraulic motors 51 or their associated functions in order to help synchronize or tune the system. In such prior art systems, the sensors may help indicate a condition in which it is necessary to quickly de-stroke or reduce the output displacement of the pump that is flowing to the hydraulic motors. This could occur for example in a condition in which one of the hydraulic motors approaches or reaches a stalled condition, and continued flow from the pump to the hydraulic motors at the rate before the stall would cause sudden increased flow through other direction control valves to other hydraulic motors. A stalled condition occurs when a direction control valve associated with a specific hydraulic motor function is commanded to open and cause a commanded flow rate to its associated hydraulic motor function, but the commanded pressure and flow output of the pump is unable to achieve the commanded flow rate to the specific hydraulic motor function. A stalled condition can occur, for example in the event a hydraulic motor function reaches the end of its stroke or encounters a resistance that it is unable to overcome. The resulting decreased flow to the specific hydraulic motor function can then flow to the other hydraulic motor functions. This increased flow to the other hydraulic motor functions can cause objectionable erratic or jerky movement in the other hydraulic motors. Further, this increased flow can in some cases cause flow shut off to one or more of the other hydraulic motors. Synchronizing or tuning electro-hydraulic systems for transient flow conditions is a significant technical problem, because response of a variable displacement hydraulic pump to de-stroke may require so much time that the described objectionable performance characteristics can occur even though such pump response time may be measured in the range of milliseconds. Further, this problem is exacerbated with larger displacement hydraulic pumps, in which the pump response time is generally greater than with smaller displacement pumps of the same type. Further, it is desirable accomplish this with minimum cost and complexity. In the electro-hydraulic system 10 according to this invention illustrated in FIG. 1, these objectionable performance characteristics are substantially eliminated without requiring the sensors used in the prior art and without requiring precise synchronizing or tuning. When an abrupt flow change event occurs in one of the hydraulic motors of this system, flow and pressure provided to the other hydraulic motors is not substantially increased, particularly under transient conditions before the pump is able to de-stroke, to minimize unintended and uncontrolled and objectionable erratic or jerky behavior in the other hydraulic motors. The invention therefore achieves smooth operation in the electro-hydraulic system 10, even when the system is not perfectly tuned and synchronized in response timing or in command signals from the controller 30 to the pump 20 and to the valve 40. The invention provides this function under at least two conditions. One condition exists anytime one of the hydraulic motors 51 stalls and the pressure limit control of the pump 20 does not itself act fast enough to prevent erratic or jerky movement of other hydraulic motors 51. As an illustrative example of this first condition, if the pump 20 and its pressure limit control require 0.5 seconds to de-stroke the pump under a stall condition of one hydraulic motor 51, the margin relief valve 70 acts substantially aster and opens and limits pressure and flow increases to the other hydraulic motors to preclude objectionable erratic or jerky performance of the other hydraulic motors. The other condition exists anytime the pump 20 outlet flow is not fully synchronized with the position of the valve spools. As an illustrative example of this second condition, the transition between changed operator commands can be considered. The operator may be steadily commanding the pump 20 to deliver a constant output flow Q₀ (that is, the pump 20 is commanded to a set constant pump displacement D₀) which is directed to a motor 51 through an active section 41 of the direction control valve 40. The metering element 43 of the active section 41 is in a position X₀. If the operator commands a different (such as lower) flow Q₁ through the active section 41, the pump 20 has to move to a displacement D₁ and the metering element 43 has to move to a spool position X₁. These two transition movements are not fully synchronized if they do not occur simultaneously, which especially may occur if the valve spool moves faster than the pump. During this transition, if the differential pressure between the pump and the load sense resolved signal tends to exceed P_{d}, the margin relief valve 70 opens a path to reservoir 80 to prevent objectionable jerky or erratic movement of another active motor of the system.

To accomplish this, the above described load sense relief valve 60 is set to a maximum resolved system load sense pressure Pₛ having a value less than or equal to the maximum set pump outlet pressure Pₚ. Further, the differential pressure control valve 70 is set to a theoretical differential pressure limit P_{d} so that the sum of P_{d} and Pₛ is greater than or equal to the maximum set pump outlet pressure Pₚ. Thus, the value of P_{d} is set so that Pₛ≦Pₚ≦(Pₛ+P_{d}). Further, it is found that the differential pressure control valve 70 is preferably set to a differential pressure limit P_{d} such that sum of P_{d} and Pₛ is always substantially greater than the maximum set pump outlet pressure Pₚ. Thus, the actual value of P_{d} is set so that Pₛ<Pₚ<(Pₛ+P_{d}). As one illustrative example, the pressure Pₚ may be set to 207 bar (3000 psi) and the pressure Pₛ may be set to 186 bar (2700 psi). This would seem to mean that the pressure P_{d} should be set to 21 bar (300 psi). However, to achieve the desired results under both of the transient or dynamic conditions described above, it is preferred to set the pressure P_{d} to 28 bar (400 psi) or more than ten percent (10%) above the remainder of Pₚ minus Pₛ. With these settings, the margin relief valve 70 does not open until the pump pressure actually exceeds its maximum set value Pₚ but this excess Pₚ transient condition is not sufficient to result in objectionable erratic or jerky performance of the other hydraulic motors. Thus, the pump pressure Pₚ may for example actually increase to 3150 psi under this transient condition. The margin relief valve 70 opens almost immediately and discharges excess pump output to the reservoir 80 in this example, because the 3150 psi pump outlet pressure is more than 400 psi above the 2700 psi resolved load sense relief setting. If the pump 20 in this example is providing a total flow displacement of F₁ that is equal to the sum of a flow displacement F₂ to one of the hydraulic motors 51 plus a flow displacement F₃ to the other hydraulic motors 51 prior to a stall condition in the one hydraulic motor, during a transient condition immediately following a stall condition in the one hydraulic motor 51 it is necessary to reduce the flow from the pump 20 to the other hydraulic motors 51 from F₁ to F₃. During this transient condition, the system 10 operates to synchronize the system 10 and avoid objectionable erratic or jerky performance of the other hydraulic motors until the pump 20 is de-stroked to output flow F₃.

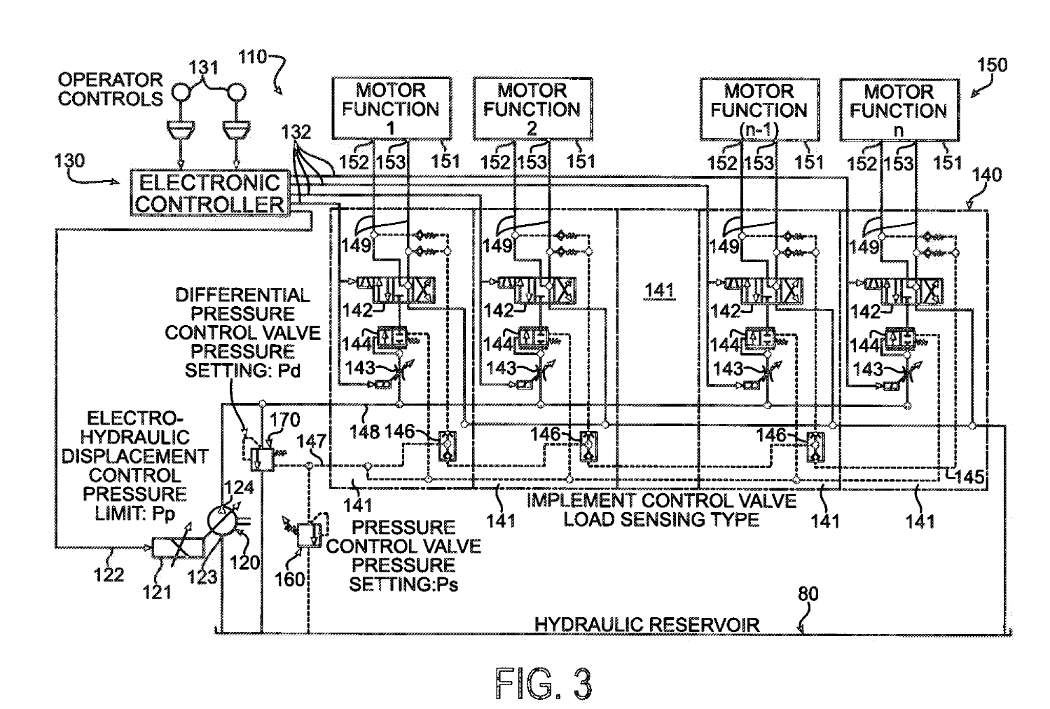

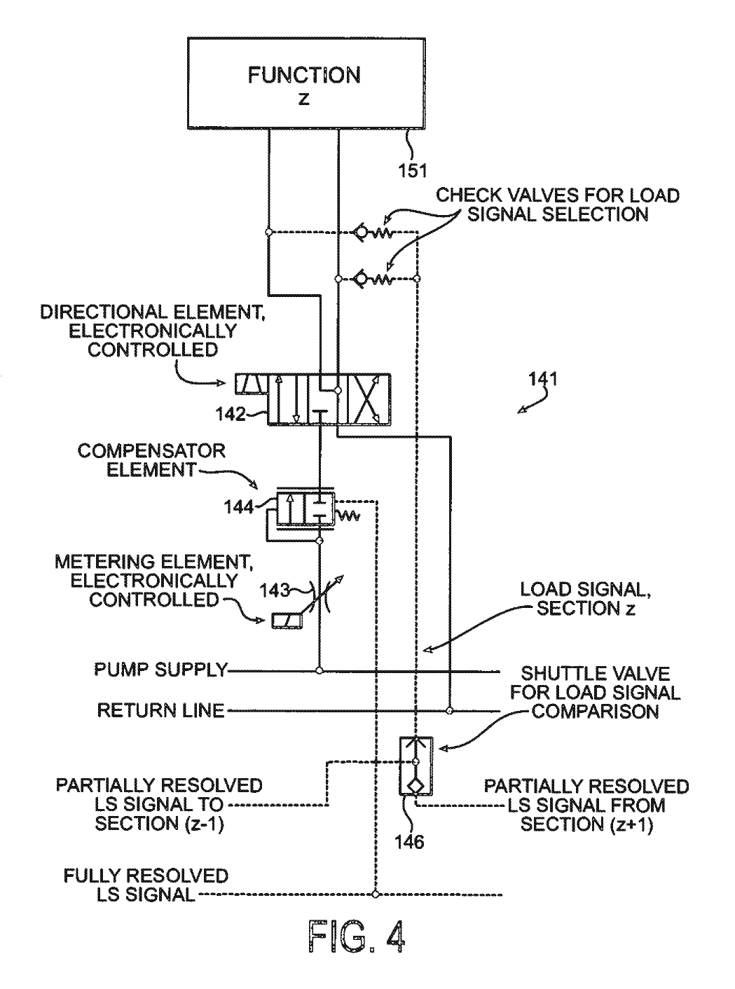

Turning now to FIGS. 3 and 4, a second embodiment is shown. In this second embodiment, the same reference numbers used in connection with describing FIGS. 1 and 2 above are used but with a prefix “1.” The above descriptions relating to FIGS. 1 and 2 apply except as otherwise noted or obvious from the FIGS. 3 and 4 schematic circuit diagrams. In FIG. 3, the load sense direction control valve 140 of the system 110 is a post compensator load sense valve instead of being a pre-compensated load sense valve as in FIGS. 1 and 2. The post compensator load sense valve 140 includes a post compensator element 144. Each compensator element 144 is a normally closed device located downstream of the metering element 143. The resolved load sense signal and a spring act in a closing direction, while the pressure downstream of the compensator element 144 is acting in the opening direction.

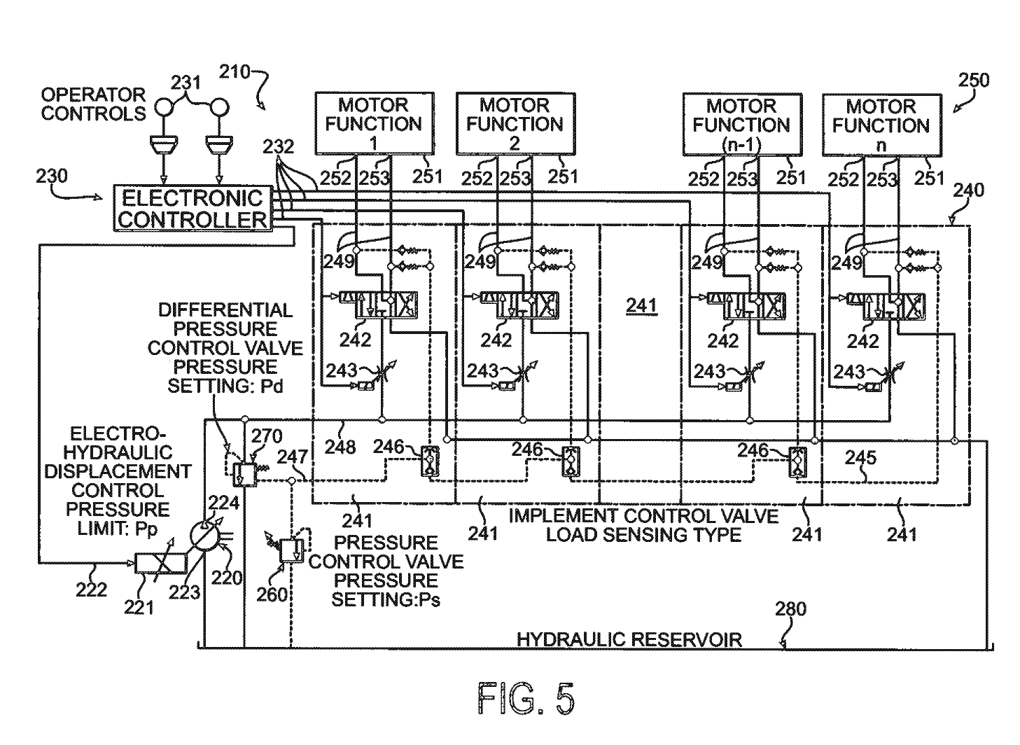

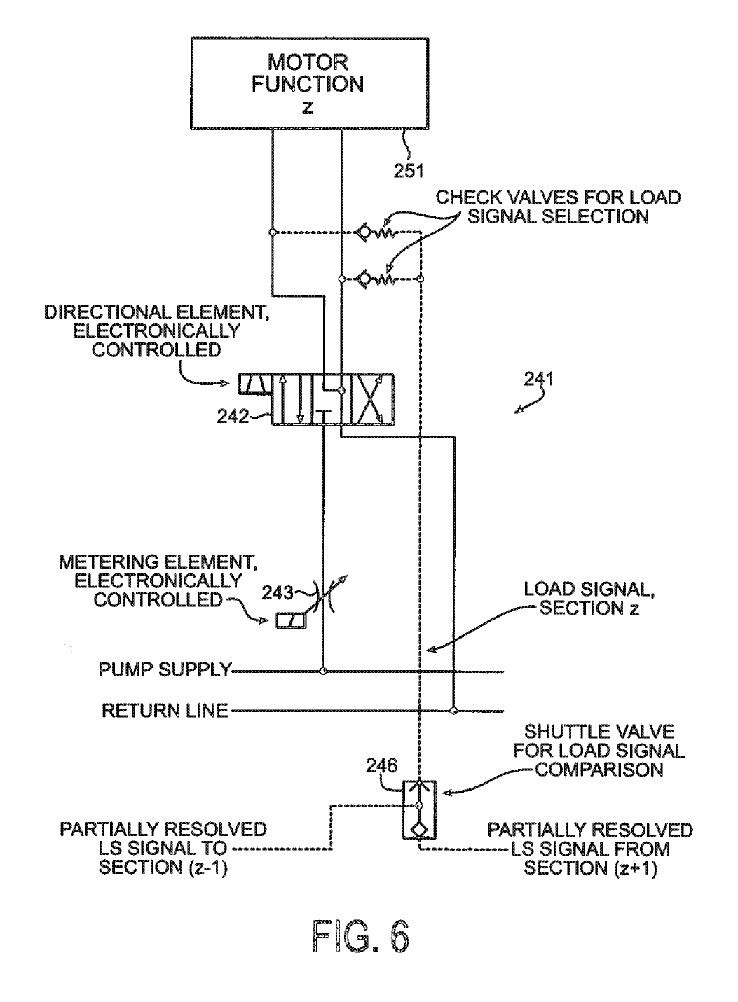

Turning now to FIGS. 5 and 6, a third embodiment is shown. In this second embodiment, the same reference numbers used in connection with describing FIGS. 1 and 2 above are used but with a prefix “2.” The above descriptions relating to FIGS. 1 and 2 apply except as otherwise noted or obvious from the FIGS. 5 and 6 schematic circuit diagrams. In FIG. 5, the load sense direction control valve 240 of the system 210 is a non-compensator load sense valve instead of being a pre-compensated load sense valve as in FIGS. 1 and 2. The non-compensator load sense valve 240 does not include a compensator.

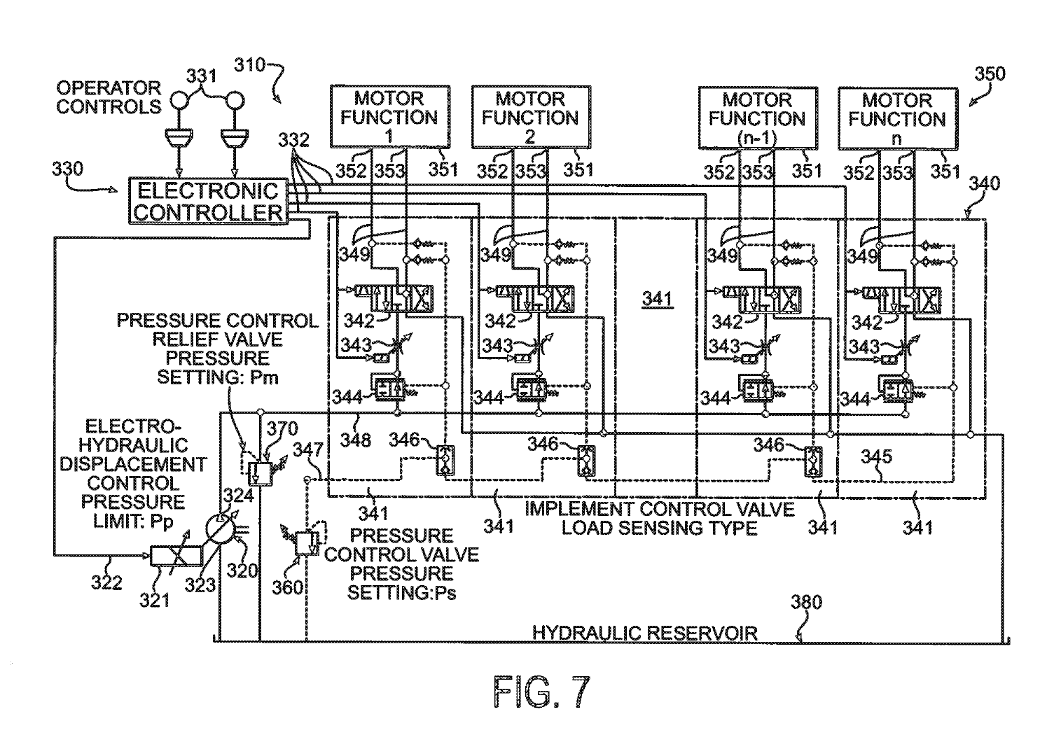

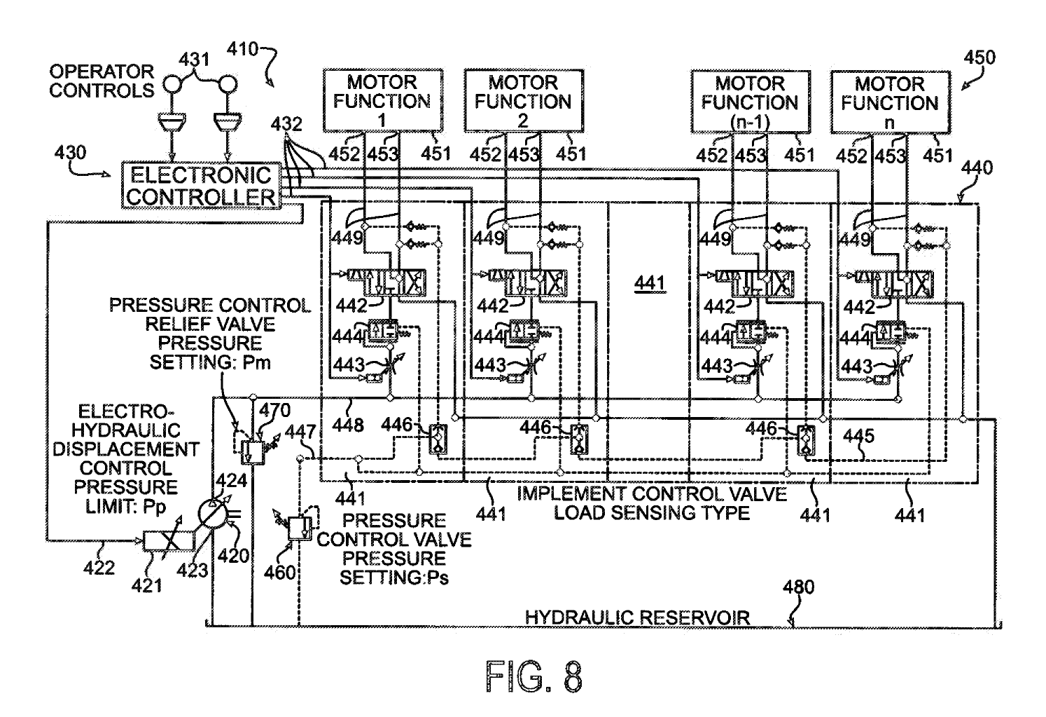

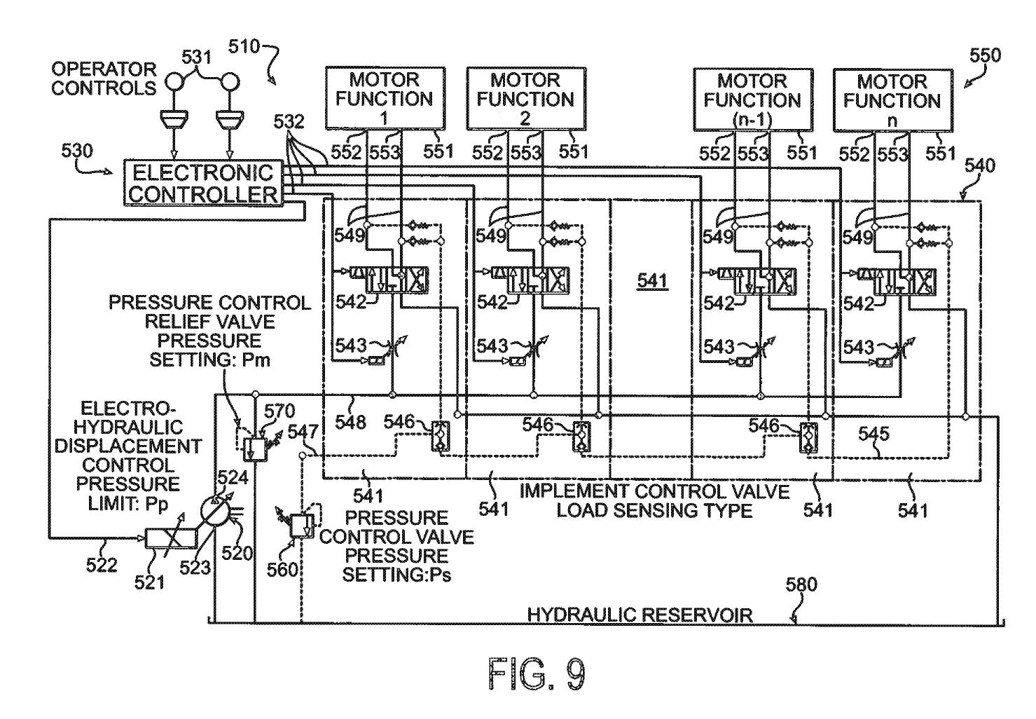

Turning now to FIGS. 7, 8 and 9, fourth, fifth and sixth embodiments are shown. In these embodiments, the same reference numbers used in connection with describing FIGS. 1 and 2 above are used but with a prefix “3”, “4,” or “5,” respectively. The above descriptions relating to FIGS. 1 and 2 apply except as otherwise noted or obvious from the FIGS. 7, 8 and 9 schematic circuit diagrams. In each of the FIG. 7-9 embodiments, the margin relief valve 70 of FIG. 1 is replaced with a pump pressure relief valve 370, 470, and 570, respectively. Each of the pump pressure relief valves 370, 470 and 570 is set to open and limit the outlet pressure of the pump 370, 470 and 570, respectively, to a maximum outlet pressure Pₘ. The value of Pₚ is set in order to be somewhere included between the value of Pₛ and Pₘ, so that, Pₛ≦Pₚ≦Pₘ and preferably Pₛ<Pₚ<Pₘ. The systems 310, 410 and 510 will preclude objectionable erratic or jerky performance described in connection with FIGS. 1 and 2 under the condition that exists anytime one of the hydraulic motors stalls and the pressure limit control of the pump does not itself act fast enough to prevent objectionable erratic or jerky movement of other hydraulic motors. However, the systems 310, 410, and 510 may not preclude such objectionable performance under the condition that exists when the pump outlet pressure is not fully synchronized with the resolved load sense pressure. The system 310 of FIG. 7 includes a pre-compensated valve element 344. The system 410 of FIG. 8 includes a post-compensated element 444. The system 510 does not include a compensator element.

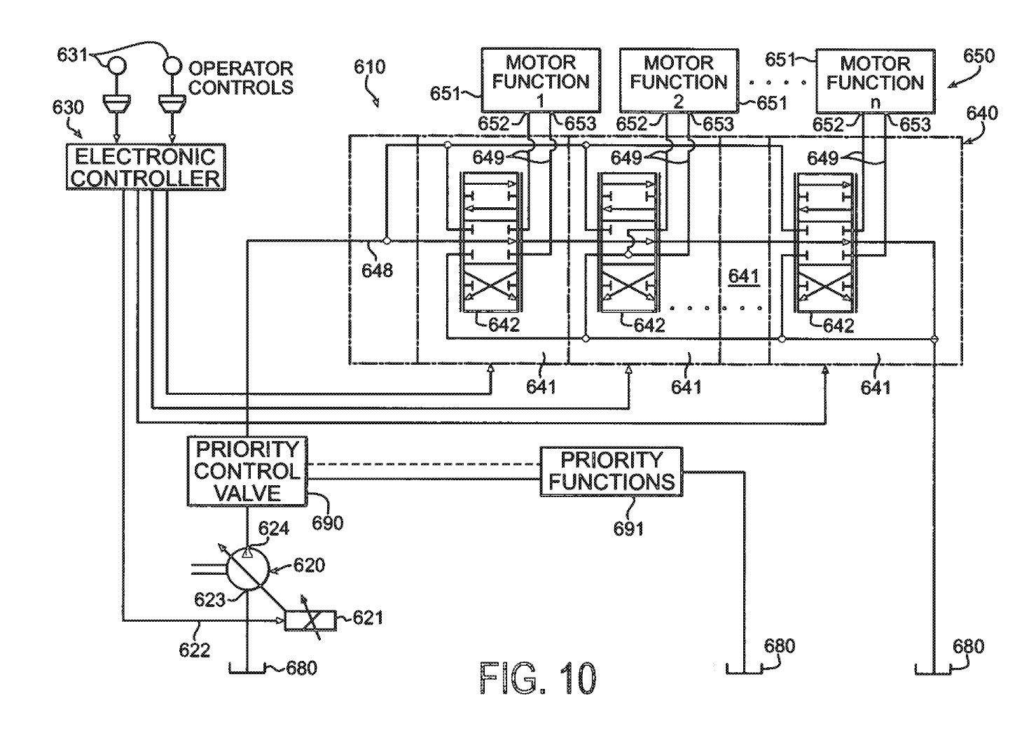

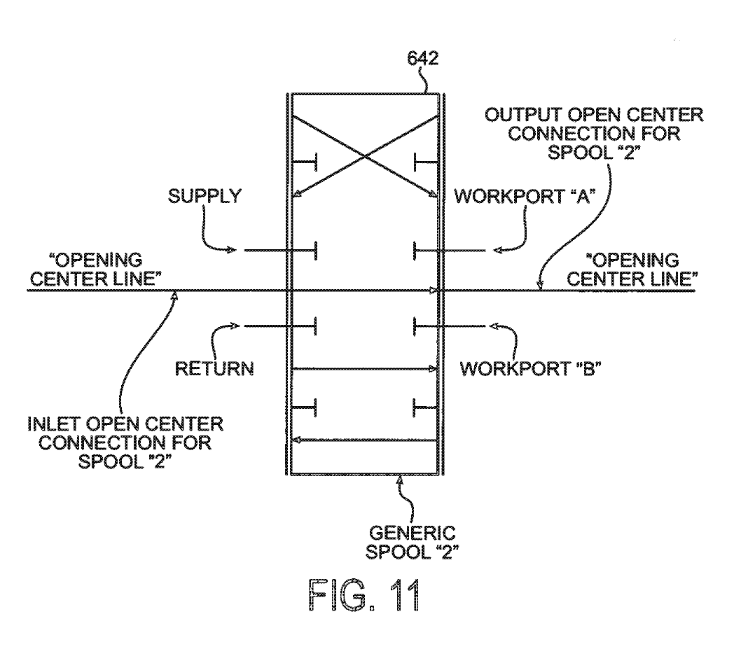

Referring now to FIGS. 10, 11 and 12, a seventh embodiment is illustrated. In these embodiments, the same reference numbers used in connection with describing FIGS. 1 and 2 above are used but with a prefix “6.” The above descriptions relating to FIGS. 1 and 2 apply except as otherwise noted or obvious from the FIGS. 10 and 11 schematic circuit diagrams. In the FIG. 10-12 electro-hydraulic system 610, the compensator element 44, load sense circuit 45, load sense relief valve 60 and margin relief valve 70 of the system 10 illustrated in FIG. 1 are not used. The FIG. 10-12 embodiment provides sole electric control of the pump 620 and direction control valve sections 641 as in the system 10 of FIG. 1. The system 610 provides a pump 620 that maintains a standby flow when no direction control elements 642 of the valve sections 641 are moved from their open center positions and no hydraulic fluid is flowing from the pump 620 to any of the hydraulic motors 651. The direction control elements 642 of the valve sections 641 are open center six way direction control elements and are illustrated schematically in FIG. 11. The connections within the valve 640 between pump supply pressure, reservoir 680 and outlet ports leading to the hydraulic motors 651 are all in parallel, and pump flow received from the pump 620 by valve 640 is directed to reservoir 680 when all of the valve sections 641 are in a neutral center position. The open center connections of the valve sections 641 are connected in series, so that the inlet open center connection of spool z is connected to the outlet open center connection of spool (z−1), z being a generic spool position. When a valve element 642 of a valve section 641 is fully or partially shifted, the open center line is restricted while the supply to work port and work port to return connections in the spool increase their areas. This generates a flow to the function, which is based on the function pressure requirement, open center line restriction and flow areas of the other connections. While FIG. 11 shows a generic valve element 642 of an open center style valve in which the element 642 has a neutral position with blocked work-ports, different configurations for the neutral position are possible.

The standby flow provided by pump 620 is sufficient for operating the priority function 691, and this standby flow is directed by a priority valve 690 to priority function 691. For example, the priority function may be a hydraulic steering function of the mobile equipment on which the electro-hydraulic system is used. The standby flow provided by pump 620 and required by priority function 691 is commanded by controller 630 when there is no operator input command to controller 630 and controller 630 is not commanding movement of the valve elements 642 and the hydraulic motors 651 do not demand flow. When controller 630 receives an input command from the operator through operator interface 631, controller 630 provides a command signal to both pump 620 and one or more valve element 642. The pump 620 is commanded to increase flow proportional to the operator input, and the valve element is shifted proportional to the operator input. If more than one hydraulic motor 651 is to be actuated, pump 620 will stroke based upon the operator input command and the commanded valve elements will shift to direct the commanded flow the motors 651.

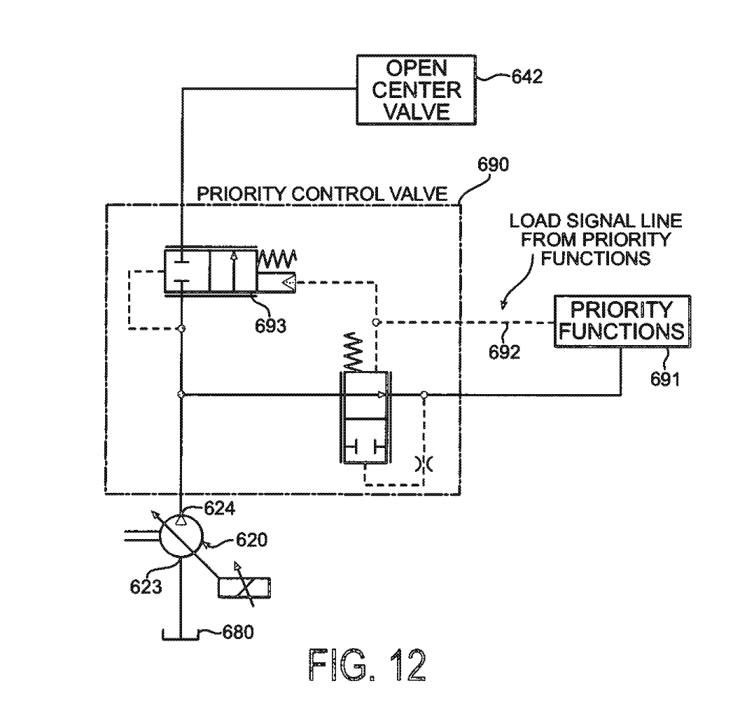

The priority valve 690 is illustrated in FIG. 12. Fluid flow required by the priority function 691 is always provided, even if other function hydraulic motors 651 are demanding fluid flow. The priority valve 690 provides all output flow from the pump 620 to the priority function 691, until a priority function hydraulic feedback signal is communicated to the valve 690 through priority communication link 692 to open valve 693 and permit fluid flow to the direction control valves 642. The priority signal indicates a condition in which all required flow to the priority function 691 is provided, and additional flow from the pump 620 is available to the valves 642 and hydraulic motors 651. Thus, in the electro-hydraulic system 610, the pump 620 and valve sections 641 are externally controlled solely by controller 630. The pump 620 maintains a standby flow used for the priority function 691, and only when the other function hydraulic motors 651 demand flow does the pump 620 stroke to meet that demand. In the illustrated embodiment, the priority function 691 is a closed center type. All or a portion of the standby priority flow is directed to the priority function 691 only when the priority function is active. Otherwise, the standby flow is available for the remaining functions. If no function is active, this flow returns to reservoir through the open center core of the valve 640. The portion of the flow going to the priority function 691 is metered by the priority valve 690 based upon the load signal through communication link 692 from priority function 691.

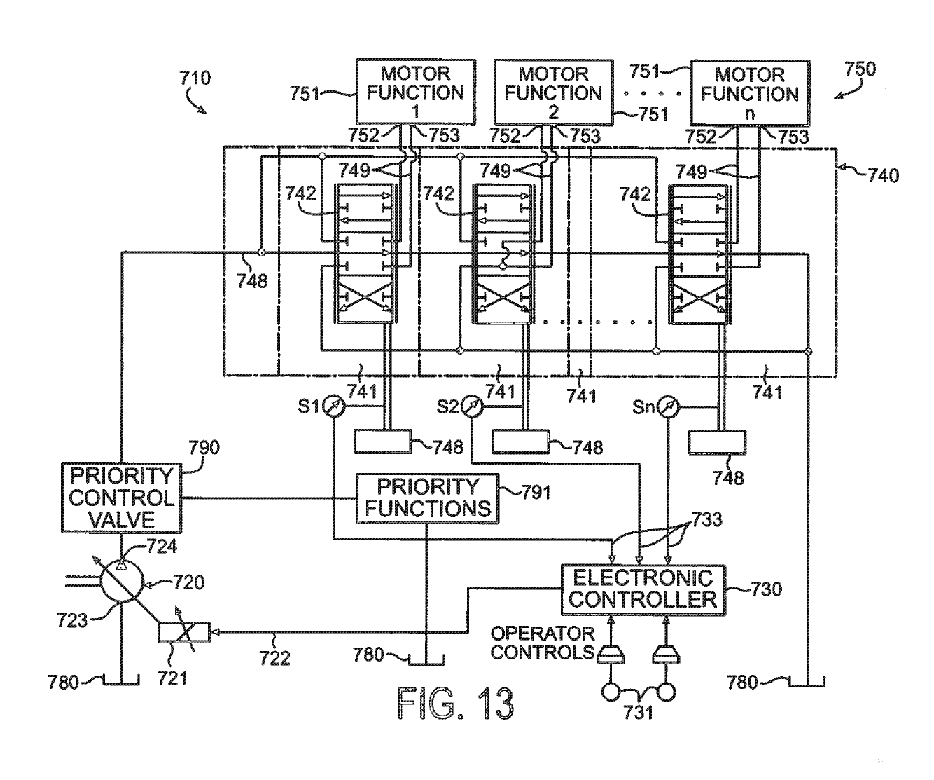

Referring now to FIG. 13, an eighth embodiment is illustrated. In this embodiment, the same reference numbers used in connection with describing FIGS. 1 and 2 above and FIGS. 10-12 above are used but with a prefix “7.” The above descriptions relating to FIGS. 1 and 2 and FIGS. 10-12 apply except as otherwise noted or obvious from the FIG. 13 schematic circuit diagrams. In the FIG. 13 electro-hydraulic system 710, the compensator element 44, load sense circuit 45, load sense relief valve 60 and margin relief valve 70 of the system 10 illustrated in FIG. 1 are not used. The FIG. 13 embodiment provides electric control of the pump 720. The system 710 provides a pump 720 that maintains a standby flow when no direction control elements 742 of the valve sections 741 are moved from their open center positions and no hydraulic fluid is flowing from the pump 720 to any of the hydraulic motors 751. The direction control elements 742 of the valve sections 741 are open center six way direction control elements and are illustrated schematically in FIG. 11 and described above. The direction control elements 742 may be controlled manually, by hydraulic pilot, pneumatically, or as otherwise selected, as indicated by reference number 748. Sensors S1, S2, Sn read the position of each valve element 742 or a parameter related to the position. These sensors are connected to controller 730 through communication links 733. The controller 730 reads the positions of valve elements 742 and commands a pump flow which is related to these valve element positions. When none of the valve elements 742 are moved from their center positions, the pump 720 is commanded by the controller 730 to deliver the standby flow required by the priority function 791.

Presently preferred embodiments of the invention are shown and described in detail above. The invention is not, however, limited to these specific embodiments. Various changes and modifications can be made to this invention without departing from its teachings, and the scope of this invention is defined by the claims set out below. Further, separate components illustrated in the drawings may be combined into a single component, and single components may be provided as multiple parts.

1. An electro-hydraulic system for controlling multiple motion functions, the system comprising a hydraulic pump, a plurality of hydraulic motors each associated with at least one of the motion functions, a plurality of direction control valve sections, at least one pump outlet valve, an electronic controller, and a hydraulic fluid reservoir,
the hydraulic pump having a pump inlet receiving hydraulic fluid from the reservoir, a pump outlet, and an electro-hydraulic pump control, the electro-hydraulic pump control setting the hydraulic fluid flow rate from the pump inlet to the pump outlet,
the direction control valve sections each including a valve inlet receiving hydraulic fluid from the pump outlet, a valve outlet, and a valve member movable in the section for controlling hydraulic fluid flow between the valve inlet and the valve outlet,
the hydraulic motors each having a hydraulic motor inlet receiving hydraulic fluid from a valve outlet and a hydraulic motor outlet returning hydraulic fluid to the hydraulic fluid reservoir,
the pump outlet valve communicating fluid flow from the pump outlet away from the direction control valve sections under predetermined conditions,
the electronic controller having an operator interface input, at least one electric output, a communication link establishing communication between at least one electric output and the electro-hydraulic pump control, and the electric output and link being the sole control input to the pump to control the hydraulic fluid flow between the pump inlet and the pump outlet,
wherein the hydraulic pump is a variable displacement pump having a pressure limiting device set to a pump outlet pressure limit value Pₚ, the hydraulic motors each provide a load sense signal to a logic circuit, the logic circuit communicates the highest load sense pressure of the hydraulic motors to the pump outlet valve, the pump outlet valve limits the maximum load sense pressure to a pressure limit value Pₛ, the system further includes a second pump outlet valve, the second pump outlet valve is a differential pressure valve that receives the maximum load sense pressure Pₛ from the logic circuit and that receives the pump outlet pressure Pₚ from the pump outlet, the differential pressure valve is set to limit the differential pressure between the pump outlet pressure Pₚ and the load sense pressure Pₛ to a differential pressure limit P_{d}, and the value of Pₚ is set to be greater than or equal to Pₛ and less than or equal to the sum of Pₛ plus P_{d}.

2. (canceled)

3. An electro-hydraulic system as set forth in claim 2, wherein the value of Pₚ is set to be greater than the value of Pₛ and less than the sum of P_{d}

4. An electro-hydraulic system as set forth in claim 3, wherein each pump outlet valve discharges hydraulic fluid from the pump outlet to the reservoir.

5. An electro-hydraulic system as set forth in claim 1, wherein the hydraulic pump is a variable displacement pump having a pressure limiting device set to a pump outlet pressure limit value Pₚ, the hydraulic motors each provide a load sense signal to a logic circuit, the logic circuit communicates the highest load sense pressure of the hydraulic motors to the pump outlet valve, the pump outlet valve limits the maximum load sense pressure to a pressure limit value Pₛ, and the value Pₛ is smaller than the value Pₚ.

6. An electro-hydraulic system as set forth in claim 1, wherein the hydraulic pump is a variable displacement pump having a pressure limiting device set to a pump outlet pressure limit value Pₚ, the hydraulic motors each provide a toad sense signal to a logic circuit, the logic circuit communicates the highest load sense pressure of the hydraulic motors to the pump outlet valve, the pump outlet valve is a differential pressure valve that receives the maximum load sense pressure Pₛ from the logic circuit and that receives the pump outlet pressure, the differential pressure valve is set to limit the differential pressure between the pump outlet pressure Pₚ and the load sense pressure Pₛ to a differential pressure limit P_{d}, and the value of Pₚ is set to be less than or equal to the sum of Pₛ plus P_{d}.

7. An electro-hydraulic system as set forth in claim 1, wherein each of the direction control valve sections includes an electro-hydraulic valve member control controlling the position of the valve member in the section, and another communication link establishes communication between another controller output and each of the electro-hydraulic valve member controls.

8. An electro-hydraulic system as set forth in claim 1, wherein each of the valve sections includes a metering element and a direction control element, and one of the controller outputs provides the sole external control for each of the valve section metering elements and direction control elements.

9. An electro-hydraulic system as set forth in claim 1, wherein each of the valve sections includes a compensator controlling the fluid pressure drop across a metering element.

10. An electro-hydraulic system as set forth in claim 1, wherein the hydraulic pump is a variable displacement pump having a pressure limiting device set to a pump outlet pressure limit value Pₚ, the hydraulic motors each provide a load sense signal to a logic circuit, the logic circuit communicates the highest load sense pressure of the hydraulic motors to the pump outlet valve, the pump outlet valve limits the maximum load sense pressure to a pressure limit value Pₛ, the system further includes a second pump outlet valve, the second pump outlet valve limits the pump outlet pressure to a pressure limit value Pₘ, and the value of Pₘ is set to be greater than Pₚ.

11. An electro-hydraulic system as set forth in claim 10, wherein each pump outlet valve discharges hydraulic fluid from the pump outlet to the reservoir.

12. An electro-hydraulic system as set forth in claim 10, wherein each of the direction control valve sections includes an electro-hydraulic valve member control controlling the position of the valve member in the section, and another communication link establishes communication between another controller output and each of the electro-hydraulic valve member controls.

13. An electro-hydraulic system as set forth in claim 12, wherein each of the valve sections includes a metering element and a direction control element, and one of the controller outputs provides the sole external control for each of the valve section metering elements and direction control elements.

14. An electro-hydraulic system as set forth in claim 10, wherein each of the valve sections includes a compensator controlling the fluid pressure drop across a metering element.

15. An electro-hydraulic system as set forth in claim 1, wherein the pump outlet valve is a priority flow control valve, the pump priority flow control valve maintains a minimum hydraulic fluid flow through the priority flow control valve to a priority function hydraulic motor when none of the first mentioned plurality of hydraulic motors is receiving hydraulic fluid flow and under all other operating conditions.

16. An electro-hydraulic system as set forth in claim 15, including a hydraulic pressure feedback communication link extending between the priority function hydraulic motor and the priority flow control valve.

17. An electro-hydraulic system as set forth in claim 15, including a position sensor (Sₙ) associated with each of the first mentioned plurality of hydraulic motors providing an electric signal output, and a communication link communicating each sensor electric signal output as an input command signal to the controller.
